(19) United States
(12) Patent Application Publication
(10) Pub. No.: US 2016/0327525 A1
(43) Pub. Date: Nov. 10, 2016

(54) SYSTEM FOR GENERATING ELASTICITY IMAGE

(71) Applicant: NATIONAL TAIWAN UNIVERSITY, Taipei (TW)

(72) Inventor: Pai-Chi LI, Taipei (TW)

(21) Appl. No.: 14/798,771

(22) Filed: Jul. 14, 2015

(30) Foreign Application Priority Data
May 8, 2015 (TW) 104114713

(51) Int. Cl. G01N 29/44; G01N 29/07

(52) U.S. Cl. CPC G01N 29/44; G01N 29/07; G01N 2291/0422; G01N 2291/02827; G01N 2203/0008

(57) ABSTRACT

A system for generating elasticity image is disclosed in the present invention. The system is provided to generate the elasticity image of an organic medium. In the system, a transmission device of a transmission-reception system is provided to transmit an ultrasound wave at a transmission location of the organic medium to generate a shear wave in the organic medium. The shear wave is transmitted to a reception location of the organic medium to generate a displacement signal. A reception device of the transmission-reception system is received the displacement signal to generate a trigger signal. A processing module is received the trigger signal to calculate a traveling speed according to a transmitting time, a receiving time, the transmission location and the reception location. The transmission-reception system is triggered to process the above mentioned steps at other location of the organic medium to generate the elasticity image.

This application claims the benefit of Taiwan Patent Application Serial No. 104114713, filed May 8, 2015, the subject matter of which is incorporated herein by reference.

### BACKGROUND OF INVENTION

1. Field of the Invention

The present invention is related to a system for generating elasticity image, and more particularly related to a system for generating elasticity image, which generates the elasticity image by transmitting ultrasound waves and receiving displacement signals at different locations of the organic medium.

2. Description of the Prior Art

Ultrasound imaging has been widely applied to medical diagnosis. Compared to other clinical medical imaging modalities such as X-ray, CT, MRI and nuclear imaging systems, ultrasound imaging is characterized as cost effective, free of ionizing radiation, non-invasive and real-time. It can also be portable, with sub-millimeter spatial resolution, and can be used for blood flow detection. Hence, ultrasound imaging has been widely utilized to assist clinical diagnosis.

Ultrasound imaging is based on reflection and backscattering of high frequency sound waves. Specifically, a probe is required for radiating a sound wave into a human body. The interaction between sound wave and the tissues inside the human body produces echoes that are detected by the probe and images are reconstructed by the system based on the received echoes.

However, conventional ultrasound imaging often has limited tissue contrast, thus making early detection of diseases difficult. In order to enhance early detection of diseases, elasticity imaging has emerged. One method for elasticity imaging is based on analysis of tissue movement before and after compression by an external device. Echo signals are used to estimate the displacement along the compression direction to compute spatial derivative of displacement. With such methods, the stiffness information (e.g. deformation and elasticity) of the medium can be available to enhance diagnosis accuracy.

Despite the widespread use of the compression based elasticity imaging methods, they cannot provide quantitative elasticity information. It is clear that an improvement is highly desirable.

### SUMMARY OF THE INVENTION

For the existing elasticity imaging methods, it is a general problem that quantitative stiffness information cannot be accessed. Accordingly, it is a main object of the present invention to provide a system for generating elasticity image which transmits ultrasound waves and receives the displacement signals at different locations of the organic medium to generate the elasticity image so as to resolve the above mentioned problem.

According to the above mentioned object, a system for generating elasticity image is provided in accordance with an object of the present invention for generating a spatial elasticity image of an organic medium. The system for generating elasticity image comprises a transmission-reception system and a processing module. The transmission-reception system comprises a transmission device and a reception device. The transmission device is utilized for transmitting an ultrasound wave to a first transmission location of the organic medium at a first time to generate a shear wave in the organic medium, and the shear wave triggers a first displacement signal to be generated at a first reception location at a second time. The reception device is utilized for receiving the first displacement signal and generating a triggering signal according to the first displacement signal. The processing module is electrically connected to the transmission device and the reception device of the transmission-reception system to receive the triggering signal and calculating a first shear wave travelling time and a first location difference according to the first time, the second time, the first transmission location, and the first reception location so as to compute a first shear wave travelling speed.

Wherein, the transmission-reception system is triggered to transmit the ultrasound wave to a second transmission location of the organic medium at a third time and to receive a second displacement generated at a second reception location of the organic medium at a fourth time, and the processing module computes a second shear wave travelling speed according to a second shear wave travelling time, which is calculated by using the third time and the fourth time, and a second location difference, which is calculated by using the second transmission location and the second reception location, and generates the spatial elasticity image according to the first shear wave travelling speed and the second shear wave travelling speed.

In accordance with a preferred embodiment of the present invention, the system for generating elasticity image further comprises a rotation device, which is elastically connected to the processing module. The transmission-reception system is disposed on the rotation device, and the processing module triggers the rotation device to rotate along a rotation direction through a rotation angle to have the transmission device and the reception device of the transmission-reception system moved to the second transmission location and the second reception location. In addition, the transmission-reception system is an one-dimensional-array probe, and the transmission device and the reception device are an ultrasound transmission probe and an ultrasound reception probe of the one-dimensional-array probe respectively. Moreover, the processing module triggers the rotation device to rotate along the rotation direction through the rotation angle N times repeatedly to generate the spatial elasticity image according to a number of N of the first shear wave travelling speeds and a number of N of the second shear wave travelling speeds, the first location difference is smaller than a wavelength of the shear wave, and the second location difference is smaller than the wavelength of the shear wave.

In accordance with a preferred embodiment of the system for generating elasticity image, the transmission-reception system is a two-dimensional-array probe, and the transmission-reception system is triggered by the processing module to transmit the ultrasound wave at the second transmission location and receive the second displacement signal at the second reception location by using different probes. In addition, the two-dimensional-array probe is a cross-shaped array probe, the first location difference is smaller than a wavelength of the shear wave, and the second location difference is smaller than the wavelength of the shear wave.

In accordance with a preferred embodiment of the system for generating elasticity image, the transmission device and the reception device are both a two-dimensional-array probe, and the transmission device is triggered by the processing module to transmit the ultrasound wave at the second transmission location by using another probe which is different from a probe of the transmission device being used for transmitting the ultrasound wave at the first transmission location, and reception device is triggered by the processing module to receive the second displacement signal at the second reception location by using another probe which is different from a probe of the reception device being used for receiving the first displacement signal, the first location difference is smaller than a wavelength of the shear wave, and the second location difference is smaller than the wavelength of the shear wave

By using the system for generating elasticity image provided in the present invention, because the system can transmit ultrasound wave and receive the displacement signal at different locations of the organic medium, the hardness condition of the whole interior of the organic medium can be detected such that the definitive diagnosis rate can be enhanced and the problem of the conventional art can be resolved.

### BRIEF DESCRIPTION OF THE DRAWINGS

The present invention will now be specified with reference to its preferred embodiment illustrated in the drawings, in which:

FIG. 1 is a block diagram of the system for generating elasticity image in accordance with a first preferred embodiment of the present invention;

FIG. 2 is a 3D schematic view of the system for generating elasticity image in accordance with the first preferred embodiment of the present invention;

FIG. 3 is a top view of the system for generating elasticity image in accordance with the first preferred embodiment of the present invention adjacent to the organic medium;

FIG. 4 is a side view of the first transmission location and the first reception location of the system for generating elasticity image adjacent to the organic medium in accordance with the first preferred embodiment of the present invention;

FIG. 5 is a side view of the second transmission location and the second reception location of the system for generating elasticity image adjacent to the organic medium in accordance with the first preferred embodiment of the present invention;

FIG. 6 is a schematic view showing the rebuild image in accordance with the first preferred embodiment of the present invention;

FIG. 6A is a schematic view showing the spatial elasticity image in accordance with the first preferred embodiment of the present invention;

FIG. 7 is a top view of the system for generating elasticity image in accordance with a second preferred embodiment of the present invention;

FIG. 8 is a schematic view of the system for generating elasticity image in accordance with a third preferred embodiment of the present invention;

FIG. 9 is a schematic view of the system for generating elasticity image in accordance with a fourth preferred embodiment of the present invention;

FIG. 10 is a schematic view of the system for generating elasticity image in accordance with a fifth preferred embodiment of the present invention; and

FIG. 11 is a schematic view of the system for generating elasticity image in accordance with a sixth preferred embodiment of the present invention.

### DESCRIPTION OF THE PREFERRED EMBODIMENT

There are various embodiments of the system for generating elasticity image in accordance with the present invention, which are not repeated hereby. Only four preferred embodiments are mentioned in the following paragraph as an example.

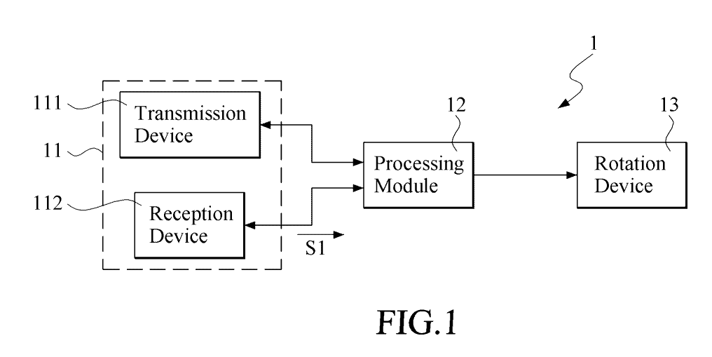

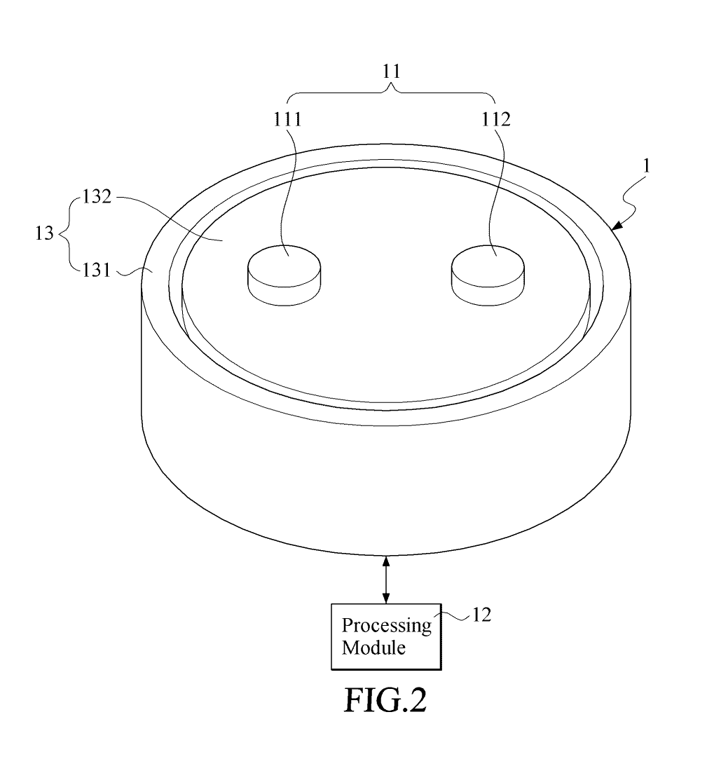

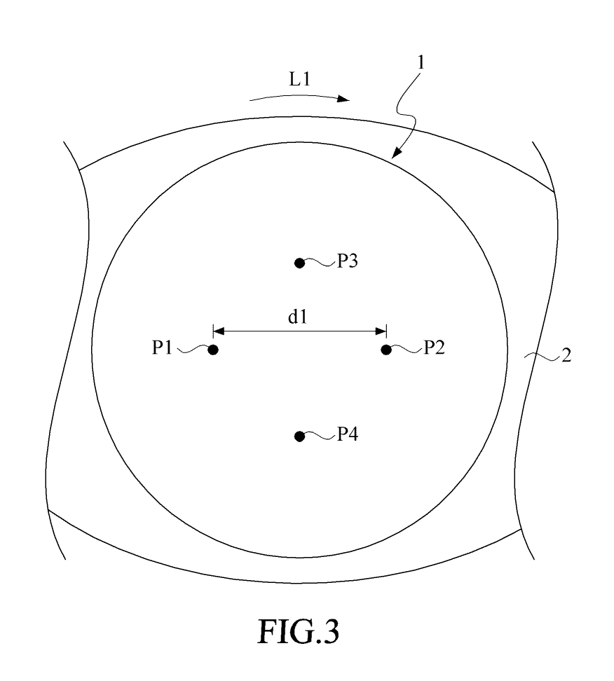

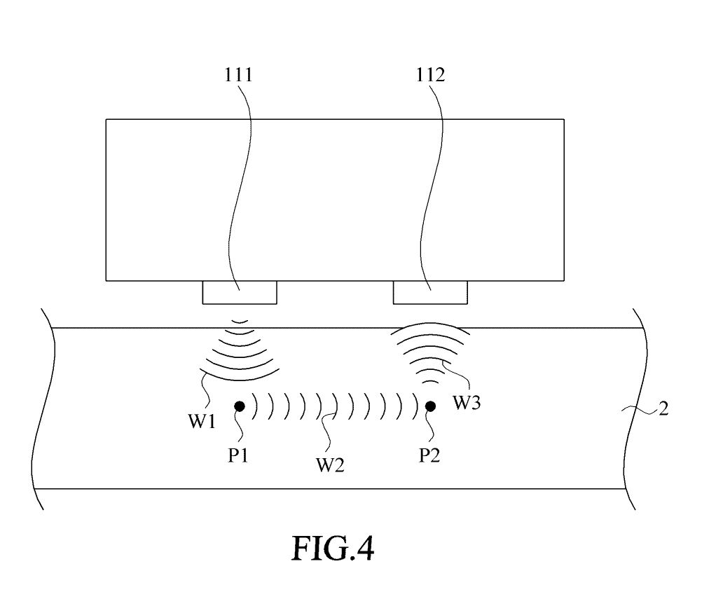

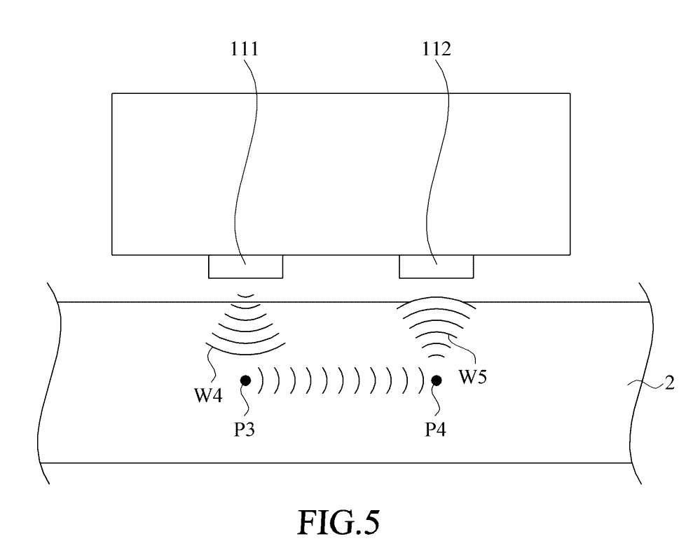

Please refer to FIGS. 1 to 5, wherein FIG. 1 is a block diagram of the system for generating elasticity image in accordance with a first preferred embodiment of the present invention, FIG. 2 is a 3D schematic view of the system for generating elasticity image in accordance with the first preferred embodiment of the present invention, FIG. 3 is a top view of the system for generating elasticity image in accordance with the first preferred embodiment of the present invention adjacent to the organic medium, FIG. 4 is a side view of the first transmission location and the first reception location of the system for generating elasticity image adjacent to the organic medium in accordance with the first preferred embodiment of the present invention, and FIG. 5 is a side view of the second transmission location and the second reception location of the system for generating elasticity image adjacent to the organic medium in accordance with the first preferred embodiment of the present invention.

As shown, the system 1 for generating elasticity image in accordance with the first preferred embodiment of the prevent invention is utilized for generating a spatial elasticity image of an organic medium 2. The organic medium 2 can be a cell, a tissue, a blood vessel or an organ (such as liver) of an organism. However, the present invention is not so restricted.

The system 1 for generating elasticity image includes a transmission-reception system 11, a processing module 12, and a rotation device 13. The transmission-reception system 11 is disposed adjacent to the organic medium 2 as shown in FIG. 4 and includes a transmission device 111 and a reception device 112. Furthermore, the transmission-reception system 11 of the first preferred embodiment includes only one transmission device 111 and one reception device 112, the transmission device 111 is an ultrasound wave transmission probe, and the reception device 112 is a reception probe. In addition, as a preferred embodiment, the central frequency of the transmission device 111 is 20 MHz, the central frequency of the reception device 112 is 40 MHz, and the reception device 112 can be further connected to an ultrasound wave system (not shown in the figure) in general.

The processing module 12 is electrically connected to the transmission device 111 and the reception device 112, such as the above mentioned ultrasound wave system, of the transmission-reception system 11. The processing module 12 can be an ordinary circuitry or chip with processing capability, such as central processing unit (CPU), graphics processing unit (GPU) or accelerated processing unit (APU). The processing module 12 can be integrated inside the reception device 112 or arranged in a separate electronic devices such as a tablet or a desktop computer.

The rotation device 13 is electrically connected to the processing module 12 and includes a rotation allocation device 131 and a rotation main body 132. The rotation main body 132 is rotatably disposed in the rotation allocation device 131 and engaged with the motor inside the rotation allocation device 131. The transmission device 111 and the reception device 112 are disposed on the rotation main body 132 by means of fitting for example. However, the present invention is not so restricted.

When using the system 1 for generating elasticity image provided in accordance with the first embodiment of the present invention, the user may use the processing module 12 to trigger (by pushing a button or other ways) the transmission device 111 of the transmission-reception system 11 to transmit an ultrasound wave W1. In the first preferred embodiment of the present invention, the transmission device 111 is disposed adjacent to the surface of the organic medium 2 and is triggered to transmit the ultrasound wave W1 at a first time. The transmission device 111 transmits the ultrasound wave W1 (transmitted along longitudinal direction) to a first transmission location P1 in the organic medium 2 at the first time to generate a shear wave W2 (transmitted along latitudinal direction) in the organic medium 2. The shear wave W2 triggers a first displacement signal W3 (transmitted along longitudinal direction) to be generated at a first reception location P2 in the organic medium 2 at a second time.

The reception device 112 is disposed adjacent to the transmission device 111, and in fact, the reception device 112 is located on the above mentioned first reception location P2 (i.e. the reception device 112 and the first reception location P2 are located on the same vertical plane). Thus, the reception device 112 receives the first displacement signal W3 at the first reception location P2 at the second time and transmits a trigger signal S1 according to the first displacement signal W3.

It is noted that the transmission device 111 is disposed at the first transmission location P1, the reception device 112 is disposed at the first reception location P2, and there has a first location difference d1 between the first transmission location P1 and the first reception location P2. In addition, the shear wave W2 has a wavelength (not shown) defined as λ. The first location difference d1 should be smaller than the wavelength of the shear wave (d1<λ) in all the preferred embodiments of the present invention. To be more precise, the location difference between the location of the transmission device 111 and the location of the reception device 112 should be smaller than the wavelength of the shear wave, and the location difference is defined as the linear distance. In the preferred embodiment of the present invention, a two-dimensional plane is used for illustration.

After receiving the trigger signal S1, the processing module 12 calculates a first shear wave travelling time and a first location difference according to the first time and the second time, as well as the first transmission location P1 and the first reception location P2 respectively. Concretely speaking, the first shear wave travelling time is the difference between the second time and the first time, the first location difference is the linear distance calculated by subtracting the coordinate of the first transmission location P1 from the coordinate of the first reception location P2. Because the first reception location P2 and the first transmission location P1 are on the same horizontal plane, the calculated location difference would be the horizontal distance. After calculating the first shear wave travelling time and the first location difference d1, the processing module 12 can further compute the first shear wave travelling speed based on the first shear wave travelling time and the first location difference d1 by dividing the first location difference d1 by the first shear wave travelling time for example.

After computing the first shear wave travelling time, the processing module 12 may store the first shear wave travelling time and trigger the motor within the rotation allocation device 131 of the rotation device 13 to rotate such that the rotation main body 132 is driven to rotate along a rotation direction L through a rotation angle so as to have the transmission device 111 and the reception device 112 of the transmission-reception system 11 moved to a second transmission location P3 and a second reception location P4 (in the present embodiment, the transmission-reception system is self-rotated. However, the present invention is not so restricted). In the first preferred embodiment, the rotation direction L is the clockwise direction as shown in FIG. 3 and the rotation angle is 90 degrees. In addition, because the transmission device 111 and the reception device 112 are fixed on the rotation main body 132, the second location difference (not shown) between the second transmission location P3 and the second reception location P4 would be identical to the first location difference d1 such that the second location difference is also smaller than the wavelength of the shear wave.

After the transmission device 111 and the reception device 112 are moved by the rotation main body 132 to the second transmission location P3 and the second reception location P4, the processing module 12 triggers the transmission device 111 of the transmission-reception system 11 to transmit an ultrasound wave W4 to the second transmission location P3 of the organic medium 2 at a third time and triggers the reception device 112 to receive a second displacement signal W5 generated at the second reception location P4 of the organic medium 2 at a fourth time such that the processing module 12 can compute a second shear wave travelling speed by using a second shear wave travelling time calculated from the third time and the fourth time and a second location difference calculated from the second transmission location and the second reception location. The generation of the second displacement signal W5 is identical to that of the first displacement signal W3 and the calculation of the second shear wave travelling speed is identical to the calculation of the first shear wave travelling speed, and thus are not repeated here. After the second shear wave travelling speed is computed, the processing module 12 accesses the first shear wave travelling speed to build up the spatial distribution of the shear wave travelling speed inside the organic medium 2 by using the first shear wave travelling speed and the second shear wave travelling speed and further transforming the speed distribution into the spatial distribution of elastic coefficient so as to generate the spatial elasticity image.

It is noted that the above mentioned first transmission location P1, the first reception location P2, the second transmission location P3, and the second reception location P4 indicate the locations inside the organic medium 2 in a narrow sense. However, in a broad meaning, these locations can be the vertical corresponding locations outside the organic medium 2. In addition, the rotation angle is 90 degrees in the first preferred embodiment, however, the present invention is not so restricted. The rotation angle can be 1 degree or other different angles, and the rotation device 13 can be repeatedly triggered to generate the rotation continuously. That is, an integrated circular scan of 360 degrees can be performed to build up a spatial elasticity image of 360 degrees. To perform the above mentioned operation, the processing module may have a build-in rotation procedure, which can be set to control the rotation angle. For example, the setting of the rotation procedure is to trigger the transmission device 111 and the reception device 112 to transmit the ultrasound wave and receive the displacement signal after every rotation though a rotation angle of one degree so as to detect the organic medium 2 along N different angles to generate N sets of data with N first shear wave travelling speeds and N second shear wave travelling speeds to generate the elasticity image, and the rotation procedure would be stopped until the rotation device is back to the original location.

Moreover, in the other embodiments, the process of transmitting the ultrasound wave W1 and receiving the first displacement signal W3 can be repeated at the same location, for example, the processing module 12 may trigger the rotation device 13 to be rotated to the next preset angle after repeatedly receiving the first displacement signal W3 at the frequency of 2000 Hz forty times. In the other embodiments, other than the above mentioned self-rotated circular scan, the transmission-reception system may be disposed on an orbit to move along a square path, a circular path, or other polygonal path to proceed the scan, and it may be set to trigger the transmission of the ultrasound wave after moving with a certain distance, for example, it may be set to execute M times of transmission and reception within a total distance, to generate the elasticity image according to the above mentioned data.

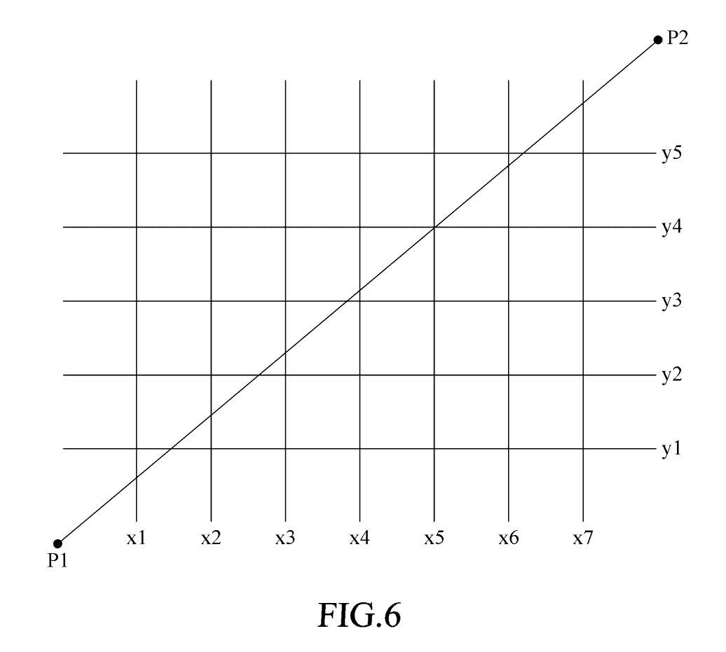

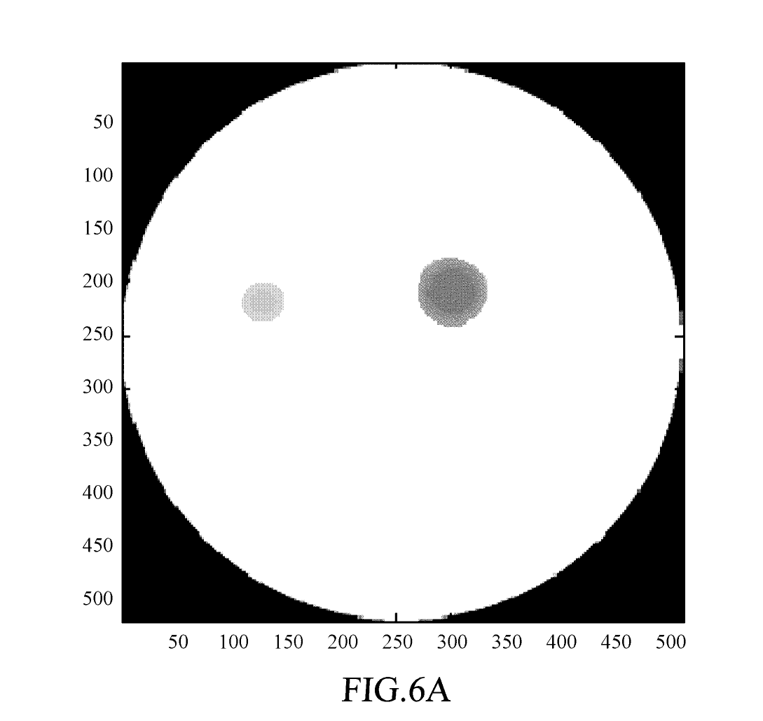

Please refer to FIG. 6 and FIG. 6A, wherein FIG. 6 is a schematic view showing the rebuild image in accordance with the first preferred embodiment of the present invention and FIG. 6A is a schematic view showing the spatial elasticity image in accordance with the first preferred embodiment of the present invention. As shown, take the first shear wave travelling speed as an example, after receiving the triggering signal S1, the processing module 12 creates grids in the target region for computing the first shear wave travelling speed such that the speed value of each grid can be calculated by using matrix, wherein L*Δs=Δt, L is length of the path of each grid through which the shear wave W2 travels along each of the angle. That is,

$$\overline{P 1 P 2} = {\sum }_{x} {\sum }_{y} L ( x , y ) ,$$

wherein P̅1̅P̅2̅ is the distance between the first transmission location P1 and the first reception location P2, and length of line P̅1̅P̅2̅ can be regarded as sum of length of travelling paths of each of the grid through which the shear wave travels.

Δs is the reverse of speed value of each grid, Δt is the time calculated from time-to-flight value of the received shear wave signals (i.e. time difference between the first time and the second time, which is also the first shear wave travelling time). Thus, if K different angles are scanned and the target region is divided into M*N grids, L would be a matrix of K*MN, Δs would be the row-vector of MN*1, and Δt would be the row-vector of K*1.

In the other preferred embodiments, if the scan process is executed every degree, i.e. K is 360, because the transmission device 111 and the reception device 112 are rotated around a fixed center, the travelling path of the shear wave W2 would be the diameter of different angles such that the value can be calculated geometrically, and Δt can be accessed from experimental data. Then, Δs can be calculated from the inverse of matrix to calculate the distribution of shear wave travelling speed within the scanning range so as to generate the diagram of speed distribution (spatial elasticity image) as shown in FIG. 6A. This diagram shows the speed distribution of shear wave within the circular scanning range and the brightness (whiteness) represents the travelling speed. The brighter the area, the higher the travelling speed and the larger the elasticity of that area.

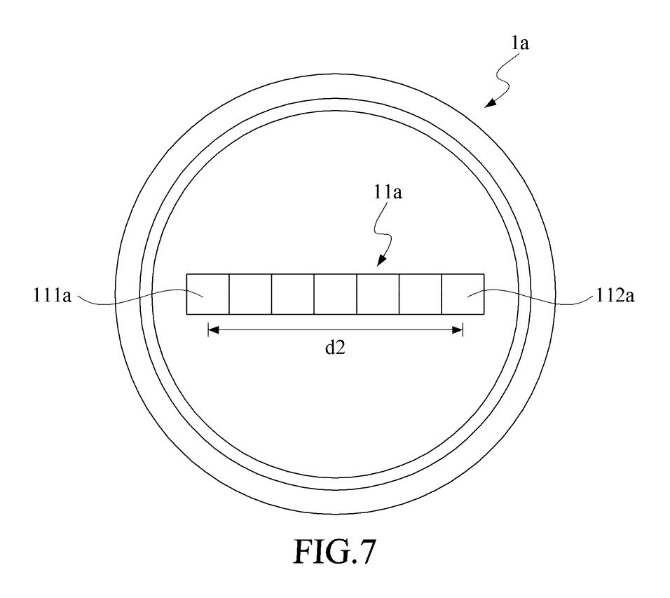

FIG. 7 is a top view of the system for generating elasticity image in accordance with a second preferred embodiment of the present invention. As shown, the difference between the system 1a for generating elasticity image of the present embodiment and that of the first preferred embodiment is that the transmission-reception system 11a of the present embodiment is an one-dimensional-array probe, and the transmission device 111a and the reception device 112a are an ultrasound transmission probe and an ultrasound reception probe of the one-dimensional-array probe. For example, the transmission device 111a is the leftmost probe in the figure, and the reception device 112a is the rightmost probe in the figure, but the first location difference d2 between the transmission device 111a and the reception device 112a should be smaller than the wavelength of the shear wave. In addition, the second location difference (not shown) should be also smaller than the wavelength of the shear wave. In the figure, the distance between the central of the transmission device 111a and the central of the reception device 112a is defined as the first location difference d2, but in the other embodiment, the location difference can be the distance between the rightmost edge and the leftmost edge The other portions of the present embodiment are identical to the first preferred embodiment and thus are not repeated here. In addition, in the first preferred embodiment and the second preferred embodiment of the present invention, the scanning process is executed by using the processing module to trigger the motor to rotate, i.e. by means of mechanical scanning technology. However, the present invention is not so restricted. In the other embodiments, the scanning process may be executed by means of electrical scanning technology, which would be discussed in the following paragraphs.

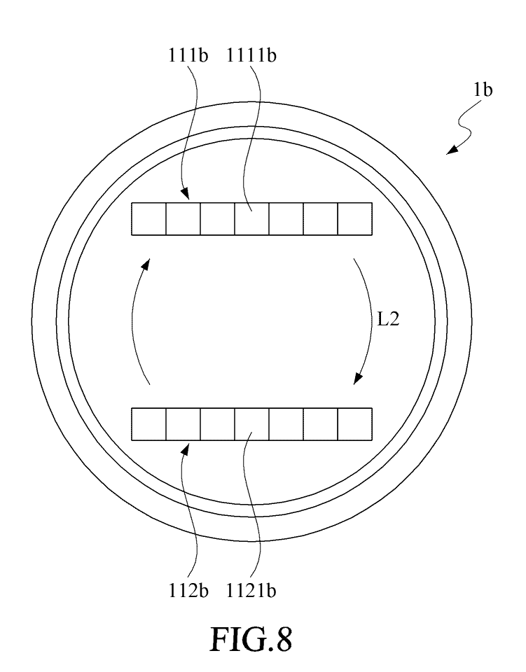

FIG. 8 is a schematic view of the system for generating elasticity image in accordance with a third preferred embodiment of the present invention. As shown, the difference between the system 1b for generating elasticity image of the present embodiment and that of the first preferred embodiment is that both the transmission device 111b and the reception device 112b are one-dimensional-array probe which can rotate along the rotation direction L2, the probe 1111b of the transmission device 111b can be used to transmit ultrasound wave, and the probe 1121b of the reception device 112b can be used to receive the second displacement signal. The other portions of the present embodiment are identical to the first embodiment and thus are not repeated here.

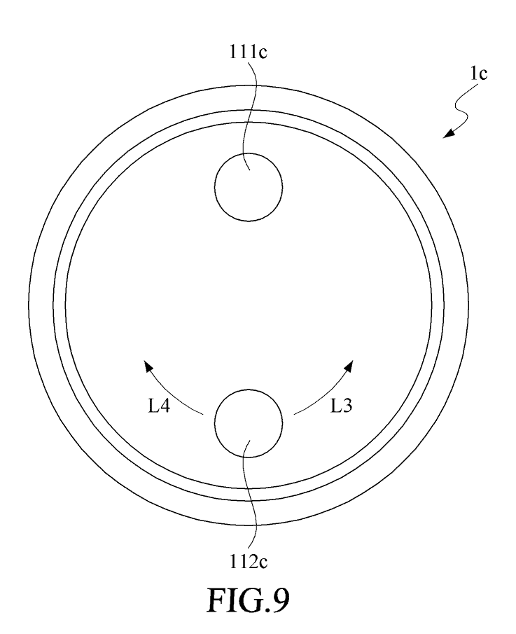

FIG. 9 is a schematic view of the system for generating elasticity image in accordance with a fourth preferred embodiment of the present invention. As shown, similar to the first preferred embodiment, the transmission device 111c and the reception device 112c of the present embodiment are both a single probe. The difference between the system 1c for generating elasticity image of the present embodiment and that of the first preferred embodiment is that, in the system 1c of the present embodiment, the transmission device 111c is controlled to be static at the original location, but the reception device 112c would be moved along the rotation direction L3 or the rotation direction L4. As a preferred embodiment, the reception device 112c is controlled to be movable within a limited angle relative to the transmission device 111c to receive the second displacement signal. This angle is the included angle between the direction from the reception device 112c to the transmission device 111c and the direction from the reception device 112c after the above mentioned movement to the transmission device 111c. In the other embodiment, the transmission device 111c is still capable to be moved along the rotation direction L4 though a rotation angle of 360 degree, and the reception device 112c can have such movement in parallel.

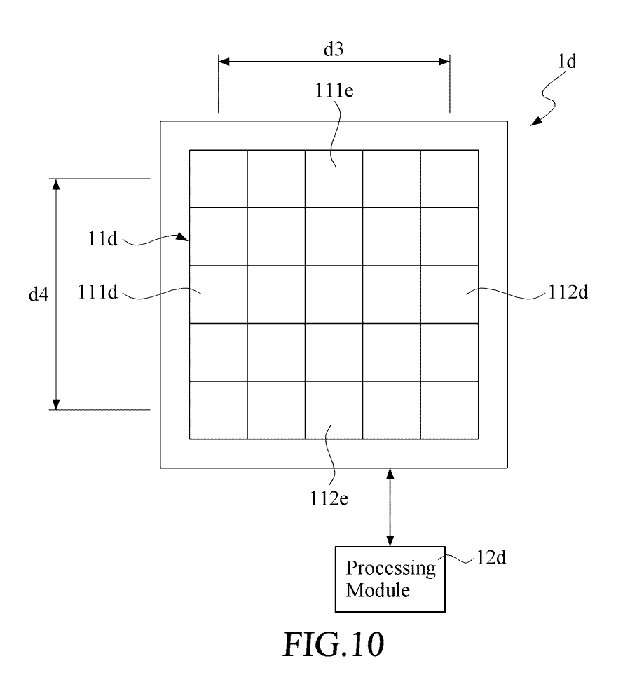

FIG. 10 is a schematic view of the system for generating elasticity image in accordance with a fifth preferred embodiment of the present invention. As shown, the difference between the system 1d for generating elasticity image of the present embodiment and that of the first preferred embodiment is that, the system 1d does not include the rotation device but uses a two-dimensional-array probe as the transmission-reception system 11d. The transmission-reception system 11d is triggered by the processing module 12d to transmit the ultrasound wave (not shown) at the second transmission location (not shown) by using a different probe and receive the second displacement signal (not shown) at the second reception location (not shown) by using a different probe. That is, the leftmost transmission device 111d is used to transmit the ultrasound wave as the first transmission location and the rightmost reception device 112d is used to receive the first displacement signal as the first reception location, but the transmission device 111e is used to transmit the ultrasound wave as the second transmission location and the reception device 112e is used to receive the second displacement signal as the second reception location. Thus, in the present embodiment, the scanning process is executed by the way of electrical scanning rather than mechanical scanning. In addition, the first location difference d3 between the transmission device 111d and the reception device 112d is smaller than the wavelength of the shear wave, and the second location difference d4 between transmission device 111e and the reception device 112e is smaller than the wavelength of the shear wave. In the figure, the distance between the central of the transmission device 111d and the central of the reception device 112d is defined as the first location difference d3, and the distance between the central of the transmission device 111e and the central of the reception device 112e is defined as the second location difference d4, but in the other embodiment, the location difference can be the distance between the rightmost edge and the leftmost edge. The other portions of the present embodiment are identical to that of the first preferred embodiment and thus are not repeated here. In addition, the above mentioned transmission-reception system 11d can be a cross-shaped array probe (not shown, but can be understood as two one-dimensional-array probes cross each other). However, the present invention is not so restricted.

In addition, it is noted that the processing module 12d may have a build-in transmission-reception procedure. That is, after the processing module 12d receives the displacement signal from the reception device 112d, the processing module 12d triggers one of the probes of the transmission-reception system 11d as the transmission device 111e to transmit the ultrasound wave according to the transmission-reception procedure, and triggers one of the probes of the transmission-reception system 11d as the reception device 112e to receive the displacement signal so as to compute travelling speed of the shear wave in each space region to generate the spatial elasticity image.

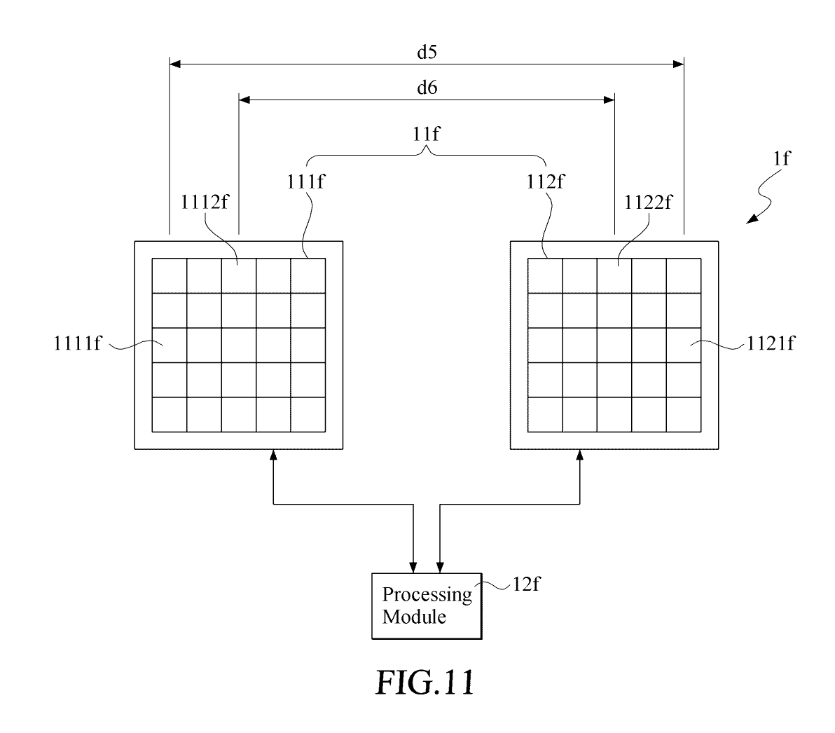

FIG. 11 is a schematic view of the system for generating elasticity image in accordance with a sixth preferred embodiment of the present invention. As shown, the difference between the system 1f for generating elasticity image of the present embodiment and that of the first preferred embodiment is that the system 1f does not include the rotation device but both the transmission device 111f and the reception device 112f of the transmission-reception system 11f are two-dimensional-array probe. The ultrasound waves transmitted at the first transmission location and the second transmission location may be transmitted by different probes in the transmission device 111f (such as the probe 1111f and the probe 1112f in the figure respectively). Similarly, the first displacement signal (not shown) and the second displacement signal (not shown) at the first reception location and the second reception location respectively can be received by using different probes (such as the probe 1121f and the probe 1122f in the figure). That is, the difference between the present embodiment and that of the fifth preferred embodiments is the transmission and reception probes. In the first preferred embodiment, the same probe (i.e. the transmission device 111) is used for transmitting ultrasound wave at the first transmission location and the second transmission location, and the same probe (i.e. the reception device 112) is used for receiving the displacement signals at the first reception location and the second reception location. The first location difference d5 between the transmission probe 1111f and the reception probe 1121f must be smaller than the wavelength of the shear wave, the second location difference d6 between the transmission probe 1112f and the reception probe 1122f must be smaller than the wavelength of the shear wave. In the figure, the distance between the central of the transmission probe 1111f and the central of the reception probe 1121b is defined as the first location difference d5, and the distance between the central of the transmission probe 1112f and the central of the reception probe 1122f is defined as the second location difference d6, but in the other embodiment, the location difference can be the distance between the rightmost edge and the leftmost edge.

Moreover, it should be noted that the processing module 12f may have a build-in transmission-reception procedure. That is, after each reception of the displacement signal from a probe in the reception device 112f, the processing module 12f triggers another probe in the transmission device 111f to transmit ultrasound wave and triggers another probe in the reception device 112f to receive the displacement signal so as to compute travelling speed of the shear wave in each of the space region to generate the spatial elasticity image.

In conclusion, by using the system for generating elasticity image provided in the present invention, because the system can transmit ultrasound wave and receive the displacement signal at different locations of the organic medium, the hardness condition of the whole interior of the organic medium can be detected such that the definitive diagnosis rate can be enhanced and the problem of the conventional art can be resolved.

The detail description of the aforementioned preferred embodiments is for clarifying the feature and the spirit of the present invention. The present invention should not be limited by any of the exemplary embodiments described herein, but should be defined only in accordance with the following claims and their equivalents. Specifically, those skilled in the art should appreciate that they can readily use the disclosed conception and specific embodiments as a basis for designing or modifying other structures for carrying out the same purposes of the present invention without departing from the scope of the invention as defined by the appended claims.

What is claimed is:

1. A system for generating elasticity image, for generating a spatial elasticity image of an organic medium, comprising:
a transmission-reception system, comprising:
a transmission device, utilized for transmitting an ultrasound wave to a first transmission location of the organic medium at a first time to generate a shear wave in the organic medium, and the shear wave triggering a first displacement signal to be generated at a first reception location at a second time; and
a reception device, utilized for receiving the first displacement signal and generating a triggering signal according to the first displacement signal; and
a processing module, electrically connected to the transmission device and the reception device of the transmission-reception system to receive the triggering signal and calculating a first shear wave travelling time and a first location difference according to the first time, the second time, the first transmission location, and the first reception location so as to compute a first shear wave travelling speed;
wherein, the transmission-reception system is triggered to transmit the ultrasound wave to a second transmission location of the organic medium at a third time and to receive a second displacement generated at a second reception location of the organic medium at a fourth time, and the processing module computes a second shear wave travelling speed according to a second shear wave travelling time, which is calculated by using the third time and the fourth time, and a second location difference, which is calculated by using the second transmission location and the second reception location, and generates the spatial elasticity image according to the first shear wave travelling speed and the second shear wave travelling speed.

2. The system for generating elasticity image of claim 1, further comprising a rotation device, elastically connected to the processing module, wherein the transmission-reception system is disposed on the rotation device, and the processing module triggers the rotation device to rotate along a rotation direction through a rotation angle to have the transmission device and the reception device of the transmission-reception system moved to the second transmission location and the second reception location.

3. The system for generating elasticity image of claim 2, wherein the transmission-reception system is an one-dimensional-array probe, and the transmission device and the reception device are an ultrasound transmission probe and an ultrasound reception probe of the one-dimensional-array probe respectively.

4. The system for generating elasticity image of claim 2, wherein the processing module triggers the rotation device to rotate along the rotation direction through the rotation angle N times repeatedly to generate the spatial elasticity image according to a number of N of the first shear wave travelling speeds and a number of N of the second shear wave travelling speeds.

5. The system for generating elasticity image of claim 2, wherein the first location difference is smaller than a wavelength of the shear wave, and the second location difference is smaller than the wavelength of the shear wave.

6. The system for generating elasticity image of claim 1, wherein the transmission-reception system is a two-dimensional-array probe, and the transmission device is triggered by the processing module to transmit the ultrasound wave at the second transmission location by using another probe which is different from a probe of the transmission device being used for transmitting the ultrasound wave at the first transmission location, and reception device is triggered by the processing module to receive the second displacement signal at the second reception location by using another probe which is different from a probe of the reception device being used for receiving the first displacement signal.

7. The system for generating elasticity image of claim 6, wherein the two-dimensional-array probe is a cross-shaped array probe.

8. The system for generating elasticity image of claim 6, wherein the first location difference is smaller than a wavelength of the shear wave, and the second location difference is smaller than the wavelength of the shear wave.

9. The system for generating elasticity image of claim 1, wherein the transmission device or the reception device is a two-dimensional-array probe, and the transmission device is triggered by the processing module to transmit the ultrasound wave at the second transmission location by using another probe which is different from a probe of the transmission device being used for transmitting the ultrasound wave at the first transmission location, and reception device is triggered by the processing module to receive the second displacement signal at the second reception location by using another probe which is different from a probe of the reception device being used for receiving the first displacement signal.

10. The system for generating elasticity image of claim 9, wherein the first location difference is smaller than a wavelength of the shear wave, and the second location difference is smaller than the wavelength of the shear wave.
